(19) United States
(12) Patent Application Publication
(10) Pub. No.: US 2016/0314629 A1
(43) Pub. Date: Oct. 27, 2016

(54) GPS-Enabled On Demand Vehicle Tracking Via A Mobile Software Application

(71) Applicant: Ford Global Technologies, LLC, Dearborn, MI (US)

(72) Inventors: Mark A. Cuddihy, New Boston, MI (US); Iskander Farooq, Novi, MI (US)

(21) Appl. No.: 14/693,298

(22) Filed: Apr. 22, 2015

(51) Int. Cl. G07C 5/06; G01S 19/42; H04W 4/04; G07C 5/00

(52) U.S. Cl. CPC G07C 5/06; G07C 5/008; G01S 19/42; H04W 4/046

(57) ABSTRACT

An on demand tracking system for a vehicle includes a mobile device configured to establish a connection with the vehicle using a unique identifier, in response to receiving geographic coordinates of the vehicle, to provide to a remote server data defining geographic boundaries encompassing the coordinates without explicitly identifying the coordinates to the remote server to request a map, to display the map, and to delete the coordinates.

### TECHNICAL FIELD

The present disclosure relates to systems and methods for providing GPS-enabled on demand vehicle tracking.

### BACKGROUND

In various situations an owner of a vehicle may have the need to determine vehicle's location. Vehicle tracking is often implemented by installing an aftermarket locator device, e.g., a transponder, in the vehicle. The locator device periodically transmits its location to a server belonging to the locator device manufacturer or distributor. The server in turn makes the location information available to the owner.

In other situations the vehicle owner may have the need to view a live video feed or a video feed snapshot from an interior of the vehicle. A video camera system may, for example, be implemented in the vehicle to determine whether a driver is in a drowsy state by monitoring the driver's head and body position. The video camera system may also be implemented in the vehicle to determine whether a primary driver, e.g., an adult or an experienced driver, or a secondary driver, e.g., a teenager or a novice driver, is operating the vehicle. The vehicle owner may desire to preserve privacy during a wireless network transmission of the interior vehicle video data.

### SUMMARY

An on demand tracking system for a vehicle includes a mobile device configured to establish a connection with the vehicle using a unique identifier, in response to receiving geographic coordinates of the vehicle, to provide to a remote server data defining geographic boundaries encompassing the coordinates without explicitly identifying the coordinates to the remote server to request a map, to display the map, and to delete the coordinates.

A method for tracking a vehicle includes establishing a connection with the vehicle using a unique identifier, in response to receiving geographic coordinates of the vehicle, providing to a remote server a request for a map, the request including data defining geographic boundaries encompassing the coordinates without explicitly identifying the coordinates to the remote server, displaying the map, and deleting the coordinates.

A vehicle includes a vehicle modem configured to, in response to a request from a mobile device for a location of the vehicle, retrieve geographic coordinates describing the location and send to the mobile device a one-time response including the coordinates unless another request from the mobile device is received.

### BRIEF DESCRIPTION OF THE DRAWINGS

FIG. 1 is a block diagram illustrating a GPS-enabled on demand vehicle tracking system;

FIG. 2 is a flowchart illustrating an algorithm for implementing vehicle tracking using a GPS-enabled on demand tracking system;

FIG. 3 is a flowchart illustrating an algorithm for displaying vehicle location in response to receiving vehicle location coordinates;

FIG. 4 is a flowchart illustrating an algorithm for establishing an initial connection between a mobile device and a vehicle modem; and

FIG. 5 is a flowchart illustrating an algorithm for displaying a vehicle interior image in response to receiving a video feed snapshot.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

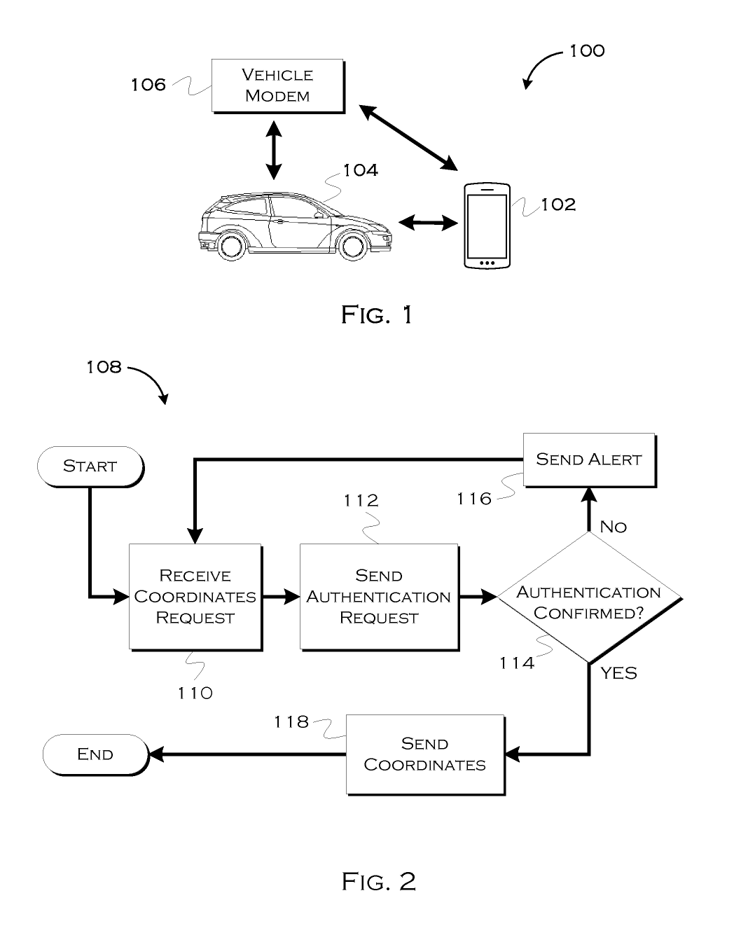

In FIG. 1 a vehicle tracking system 100 is shown. The vehicle tracking system 100 includes a mobile device 102 and a vehicle 104 having a vehicle modem 106. The vehicle modem 106 is a vehicle control module configured to communicate with a vehicle data bus (e.g., a CAN bus) that provides access to various other vehicle modules, such as an engine control module (ECM), a telematics/infotainment module, and a navigation module having a Global Positioning System (GPS) receiver. In other scenarios the vehicle modem 106 may be configured to include an integrated GPS receiver, a radio transmitter, and other features.

The vehicle modem 106 communicates with the mobile device 102 to transmit and receive telecommunications data. In one example, the vehicle modem 106 may be configured to communicate with the mobile device 102 over a digital network using any number of data communication protocols, e.g., GSM (2G), ITU IMT-2000 (3G), IMT-Advanced (4G), IEEE 802.11a/b/g/n (Wi-Fi), WiMax, ANT™, ZigBee®, Bluetooth®, Near Field Communications (NFC), and others.

The vehicle modem 106 may have a unique identification code (hereinafter, a unique identifier) assigned to the vehicle 104 and associated with a vehicle identification number (VIN) of the vehicle 104. The mobile device 102 may use the unique identifier to establish a network connection with the vehicle 104. For example, the mobile device 102 may use a cellular communication network to establish a connection with the vehicle modem. Of course, other types of communication networks and network connections are also contemplated.

The vehicle modem 106 may transmit digital data accessible from the vehicle bus to the mobile device 102 in response to receiving a request from the mobile device 102. For example, the vehicle modem 106 may transmit a vehicle location to the mobile device 102. In another example, the vehicle modem 106 may transmit to the mobile device 102 digital data from an interior video camera feed, such as via a live video feed transmission or by sending a video feed snapshot.

The mobile device 102 is configured to receive user input, e.g., a button press, a touch screen contact, a voice command, etc. For example, the mobile device 102 may receive a request for a vehicle location via an application software graphical user interface (GUI), e.g., mobile app. As described in reference to FIG. 3, the mobile device 102, in response to receiving a request for a vehicle location, sends a request for a vehicle location to the vehicle modem 106. In another example, as described in reference to FIG. 5, the mobile device 102, in response to receiving a request for a vehicle feed snapshot, sends a request for the vehicle feed snapshot to the vehicle modem 106.

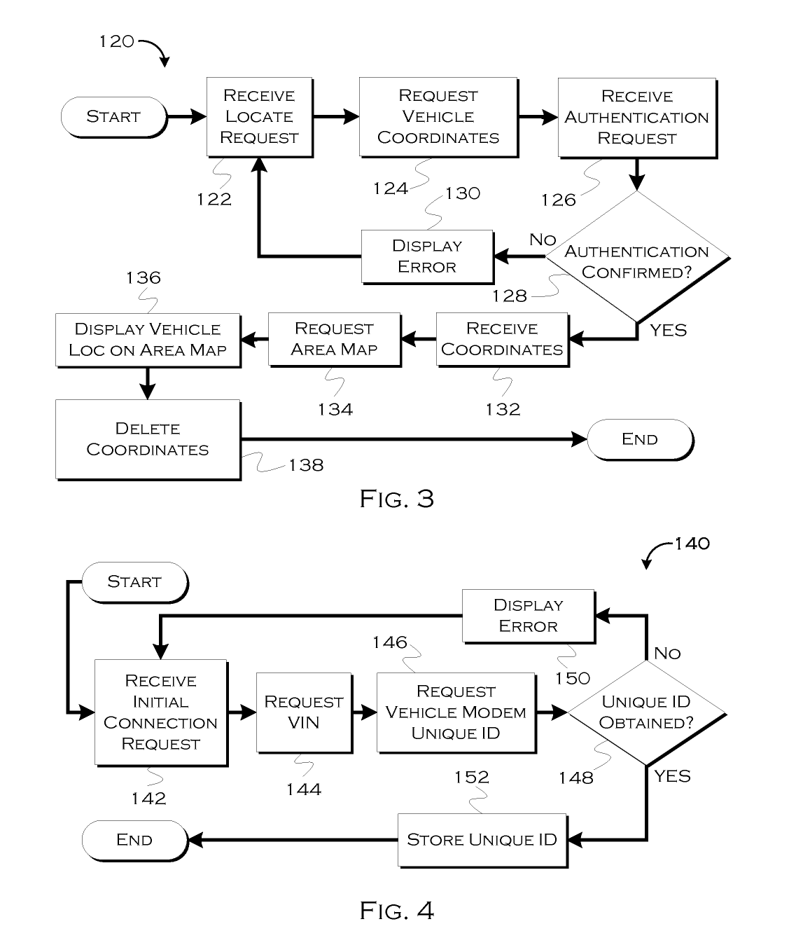

In reference to FIG. 2, a control strategy 108 for determining vehicle location is shown. The control strategy 108 may begin at block 110 where the vehicle modem 106 receives a coordinates request from the mobile device 102. At block 112, the vehicle modem 106 sends an authentication request to the mobile device 102. For example, the vehicle modem 106 may send a 128-bit random number (RAND) and request a computed 32-bit response (SRES) based on the encryption of the random number with an authentication algorithm and an individual subscriber authentication key (Ki). Of course, other authentication methods are also contemplated.

The vehicle modem 106, at block 114, determines whether the authentication has been confirmed. For example, the vehicle modem 106, in response to receiving the computed 32-bit response, may compute its own 32-bit response (SRES) and compare the received response with its own response. If the authentication has not been confirmed, e.g., the received response does not match its own computed response, the vehicle modem 106, at block 116, sends an alert to the mobile device 102 indicating that the authentication request has not been confirmed and the control strategy 108 returns to block 110.

At block 118, in response to the authentication being confirmed, e.g., the received 32-bit response matches its own computed 32-bit response, the vehicle modem 106 provides vehicle location coordinates. For example, the vehicle modem 106, in response to receiving vehicle coordinates from the navigation module, may provide the vehicle coordinates for the mobile device 102. In another example, the vehicle modem 106 may reference an integrated GPS receiver to determine the vehicle coordinates. At this point the control strategy 108 may end. In some embodiments the control strategy 108 described in FIG. 2 may be repeated in response to receiving a vehicle coordinates request or another request or notification.

In reference to FIG. 3, a control strategy 120 for displaying a vehicle location is shown. The control strategy 120 may begin at block 122 where the mobile device 102 receives a request for a vehicle location. For example, a vehicle owner may request the vehicle location of the vehicle 104 using a downloaded mobile app.

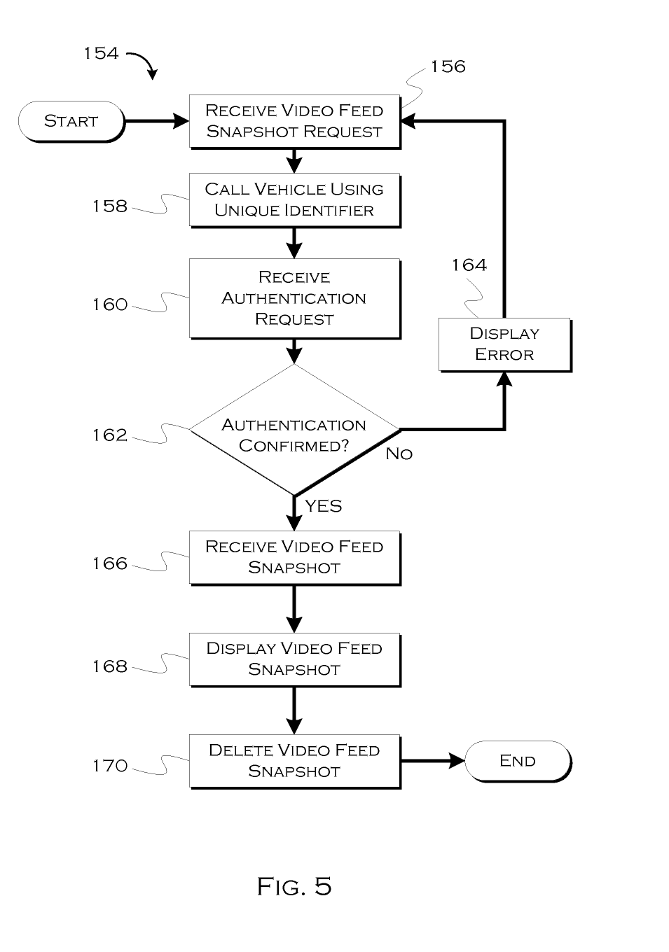

At block 124, in response to receiving a request for the vehicle location, the mobile device 102 sends a request for vehicle coordinates to the vehicle modem 106. For example, the mobile device 102 may contact the vehicle modem 106 via a communication network using the previously stored unique identifier. In some scenarios, the mobile device 102 may be paired with the vehicle modem 106 prior to an initial vehicle location request. As described in reference to FIG. 4, the pairing may be achieved using any one of a variety of methods where the mobile device 102 receives and stores the unique identifier of the vehicle modem 106.

At block 126, the mobile device 102 receives authentication request from the vehicle modem 106. For example, the mobile device 102 may receive a 128-bit random number (RAND) and may compute a 32-bit signed response (SRES) based on the encryption of the random number with an authentication algorithm and an individual subscriber authentication key (Ki). The mobile device 102 determines at block 128 whether authentication was confirmed. If the authentication was not confirmed, the mobile device 102 displays an error at block 130 and the control strategy 120 returns to block 122.

In response to authentication being confirmed, the mobile device 102 receives vehicle location coordinates at block 132. The mobile device 102, at block 134, requests a map of a location associated with the received vehicle location coordinates. For example, the mobile device 102 may request a local area map from Google™ Maps or another mapping service.

In one example, the mobile device 102 may be configured to determine a privacy region near or about the vehicle location coordinates, such that the request to the mapping service for a local area map will contain the coordinates of the privacy region and will not contain the vehicle location coordinates. The mobile device 102 may, for example, determine the privacy region by selecting a geographic region, e.g., city, state, country, etc, containing the vehicle location coordinates. In another example, the mobile device 102 may determine the privacy region by modifying, e.g., using addition, subtraction, etc., latitude and longitude of the vehicle location coordinates by a varying number of degrees, minutes, and seconds.

In one example, the mobile device 102 may receive the vehicle location coordinates of N40° 45′1.814″ and W73° 59′36.38″. The mobile device 102 may then determine the privacy region about the vehicle location coordinates prior to requesting an area map from the mapping service. For example, the privacy region may include latitude maximum, latₘₐₓ, latitude minimum, latₘᵢₙ, longitude maximum, longₘₐₓ, and longitude minimum, longₘᵢₙ, determined by adding and subtracting varying number of degrees, minutes, and seconds to the vehicle location coordinates. The mobile device 102 will then request the area map based on the latₘₐₓ, longₘₐₓ, longₘᵢₙ of the privacy region.

At block 136, the mobile device 102 displays vehicle location coordinates on the provided area map. For example, the mobile device 102 may be configured to include a zoom feature such that a more exact location of the vehicle 104 may be viewed. The mobile device 102, at block 138, selectively deletes the vehicle location coordinates from memory. For example, the mobile device 102 may delete the vehicle location coordinates after a predetermined time, e.g., 10 minutes. In another example, the mobile device 102 may delete the vehicle location coordinates in response to a request from the user. At this point the control strategy 120 may end. In some embodiments the control strategy 120 described in FIG. 3 may be repeated in response to receiving a request to determine vehicle location or another notification or request.

In reference to FIG. 4, a control strategy 140 for pairing the mobile device 102 and the vehicle modem 106 is shown. The control strategy 140 may begin at block 142 where the mobile device 102 receives an initial connection request. For example, the mobile device 102 may receive the connection request following a mobile app download to the mobile device 102 by the vehicle owner. The mobile device 102, at block 144, requests that the VIN associated with the vehicle 104 be entered by the user. Of course, other methods of obtaining the VIN, such as scanning a VIN barcode, are also contemplated.

At block 146, the mobile device 102 requests the unique identifier of the vehicle modem 106, in response to receiving the VIN. For example, the mobile device 102 may request a unique identifier associated with the VIN from a vehicle manufacturer server using a proprietary system access, such as MyLincoln Touch®. At block 148, the mobile device 102 determines whether the unique identifier associated with the VIN has been obtained. If the unique identifier has not been obtained, the mobile device 102 displays an error, at block 150, and the control strategy 140 returns to block 142.

At block 152, the mobile device 102, in response to determining that the unique identifier has been obtained, stores it in mobile device memory. At this point the control strategy 140 may end. In some embodiments the control strategy 140 described in FIG. 4 may be repeated in response to receiving a request for an initial connection or another notification or request. In another example, the mobile device 102 may request the VIN and the unique identifier using a short-range network connection, such as Bluetooth. The mobile device 102 may, for example, connect to the vehicle 104 using a vehicle communications and entertainment system, e.g., Ford SYNC®, and request the VIN and the unique identifier from an on-vehicle controller via the vehicle data bus.

In reference to FIG. 5, a control strategy 154 for displaying a vehicle interior image in response to receiving a video feed snapshot is shown. A control strategy for displaying a live video feed of the interior of the vehicle 104 may be implemented in a manner similar to the control strategy 154. The control strategy 154 may begin at block 156 where the mobile device 102 receives a video feed snapshot request. For example, a vehicle owner may request an interior image of the vehicle 104 using a downloaded mobile app.

At block 158, in response to receiving a request for the interior image, the mobile device 102 sends a request for a video feed snapshot to the vehicle modem 106. For example, the mobile device 102 may contact the vehicle modem 106 via a cellular communication network using a previously stored unique identifier. As discussed previously in reference to FIG. 3, the mobile device 102 may be paired with the vehicle modem 106 prior to an initial video feed snapshot request using any one of a variety of methods wherein the mobile device 102 receives and stores the unique identifier of the vehicle modem 106.

At blocks 160-164, the mobile device 102 receives and responds to an authentication request from the vehicle modem 106. Authentication methods similar to those described in reference to FIG. 3 may be implemented, however, other methods may also be applied. The mobile device 102 receives the video feed snapshot, at block 166, in response to the authentication being confirmed. At block 168, the mobile device 102 displays the received video feed snapshot.

The mobile device 102, at block 170, selectively deletes the video feed snapshot from memory. For example, the mobile device 102 may delete the video feed snapshot after a predetermined time, e.g., 10 minutes. In another example, the mobile device 102 may delete the video feed snapshot in response to a request from the user. At this point the control strategy 154 may end. In some embodiments the control strategy 154 described in FIG. 5 may be repeated in response to receiving a request to display a vehicle interior image or another notification or request.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An on demand tracking system for a vehicle comprising:
a mobile device configured to
establish a connection with the vehicle using a unique identifier,
in response to receiving geographic coordinates of the vehicle, provide to a remote server data defining geographic boundaries encompassing the coordinates without explicitly identifying the coordinates to the remote server to request a map,
display the map, and
delete the coordinates.

2. The on demand tracking system of claim 1, wherein the unique identifier is associated with a vehicle identification number (VIN) of the vehicle.

3. The on demand tracking system of claim 1, wherein the connection with the vehicle is a cellular connection.

4. The on demand tracking system of claim 1, wherein the data defining the geographic boundaries is based on a latitude and longitude of the geographic coordinates.

5. The on demand tracking system of claim 1, wherein the geographic boundaries define a city, a county, or a state.

6. The on demand tracking system of claim 1, wherein the mobile device is further configured to delete the data after a predetermined period of time.

7. The on demand tracking system of claim 1, wherein the mobile device is further configured to, in response to receiving data defining an image of an interior of the vehicle, display the image and delete the image.

8. The on demand vehicle tracking system of claim 7, wherein the mobile device is further configured to delete the image after a predetermined amount of time.

9. The on demand vehicle tracking system of claim 7, wherein the mobile device is further configured to delete the image in response to a deletion request from a mobile user.

10. A method for tracking a vehicle comprising:
establishing a connection with the vehicle using a unique identifier,
in response to receiving geographic coordinates of the vehicle, providing to a remote server a request for a map, the request including data defining geographic boundaries encompassing the coordinates without explicitly identifying the coordinates to the remote server,
displaying the map, and
deleting the coordinates.

11. The method of claim 10, wherein the unique identifier is associated with a vehicle identification number (VIN) of the vehicle.

12. The method of claim 10, wherein the connection with the vehicle is a cellular connection.

13. The method of claim 10, wherein the data defining the geographic boundaries is based on a latitude and longitude of the geographic coordinates.

14. The method of claim 10, wherein the geographic boundaries define a city, a county, or a state.

15. The method of claim 10, further comprising deleting the geographic coordinates after a predetermined period of time.

16. The method of claim 10, further comprising deleting the geographic coordinates in response to a deletion request from a user.

17. The method of claim 10, further comprising, in response to receiving data defining an image of an interior of the vehicle, displaying the image and deleting the image.

18. The method of claim 17, further comprising deleting the image after a predetermined amount of time.

19. The method of claim 17, further comprising deleting the image in response to a deletion request from a user.

20. A vehicle comprising:
a vehicle modem configured to, in response to a request from a mobile device for a location of the vehicle, retrieve geographic coordinates describing the location and send to the mobile device a one-time response including the coordinates unless another request from the mobile device is received.
